(19) United States
(12) Patent Application Publication
(10) Pub. No.: US 2009/0210321 A1
(43) Pub. Date: Aug. 20, 2009

(54) METHOD AND SYSTEM FOR CLASSIFYING AND RECOMMENDING WINE

(75) Inventor: Alyssa J. Rapp, Winnetka, IL (US)

Correspondence Address: QUINN LAW GROUP, PLLC, 39555 ORCHARD HILL PLACE, SUITE # 520, NOVI, MI, 48375, US

(73) Assignee: Bottlenotes, Inc., Palo Alto, CA (US)

(21) Appl. No.: 12/366,918

(22) Filed: Feb. 6, 2009

Related U.S. Application Data
(60) Provisional application No. 61/028,555, filed on Feb. 14, 2008.

(51) Int. Cl. G06Q 30/00; G06F 7/06; G06Q 99/00; G06F 17/30; G06N 5/02

(52) U.S. Cl. 705/27; 707/5; 706/46; 705/1; 707/E17.047; 707/E17.016

(57) ABSTRACT

A method for classifying and recommending wine includes establishing a network connection between a server and a computer, recording a wine inventory within a database management system (DBMS) of the sever, and populating the inventory with information describing the different wines. A weighted value is assigned to the information for each wine to determine a numeric bin value, and an objective personal taste profile (PTP) of the user is calculated as a number that objectively rates the user's taste preferences. The method matches a wine with the user based on the bin value and PTP, and displays a graphic of the wine on a web browser. A server-based system includes a data base management system (DBMS) and a server having an algorithm for classifying and recommending wine based on the user's PTP, and displaying a graphic of the wine on a web browser.

### CROSS REFERENCE TO RELATED APPLICATIONS

This application claims the benefit of and priority to U.S. Provisional Patent Application No. 61/028,555, filed on Feb. 14, 2008, which is hereby incorporated by reference in its entirety.

### TECHNICAL FIELD

This invention relates generally to an automated computer-based system related to wine, and more particularly to a method and a system for objectively classifying and recommending a particular wine to a user.

### BACKGROUND OF THE INVENTION

Wine is widely consumed throughout the world, but despite its enormous international popularity, wine-related terminology remains highly subjective and regional. Such subjectivity and regional variance in turn can complicate business transactions that rely to some extent on the information conveyed using such terminology. That is, a given wine has many characteristics or attributes, some of which are featured prominently on the wine label or packaging. However, the naming conventions as well as laws and regulations of the particular locales from which a wine originates can widely vary. The result can be an inconsistency in wine labeling, particularly when a particular wine is sold in a different region than that in which it is bottled. It can therefore be relatively difficult to properly and/or consistently classify a given wine. Moreover, wine drinkers—from the novice to the more experienced—might be unfamiliar with the various attributes of a wine when considering whether or not to consume that particular wine.

Given the insufficient clarity and consistency of wine-related terminology, wine recommendations made in a social or business context can be reduced to, at best, a subjective art or guessing game. For example, if a particular individual enjoys drinking Syrah, then a wine expert or interested friend or associate will often recommend yet another Syrah, or something very similar to it. Likewise, the lack of objective terminology in classifying wine and profiling the taste preferences of a wine drinker can pose unique problems when communicating with others, such as when transacting with a wine sales business or networking with other wine drinkers over the Internet.

### SUMMARY OF THE INVENTION

Accordingly, a method is provided for automatically classifying and selecting a wine for a user as set forth below. The method can be embodied in computer-executable algorithmic form, with the algorithm calculating a numeric personal taste profile (PTP) for a given user based on the user's responses to a predetermined set of questions and/or using other feedback. By matching the numeric PTP of the user with objective wine-related information stored in a database management system (DBMS), a customized wine recommendation is made to the user via display of a useful graphic of the recommended wine, such as an image of a sample label, on the user's web browser. The recommendation can be determined by ranking and scoring various wines, and then matching wine to the user's PTP.

Using the method of the invention, the recommended wine can be presented to the user with a normalized or standardized name, referred to herein as a “Universal Wine Name”, having the form: country-winery-designation-variety-vintage in an exemplary embodiment. The Universal Wine Name can be generated by selecting a country of origin of the wine in conjunction with particular data elements appropriate for that country, e.g., winery, designation, variety, vintage, etc. Along with the display of a sample label of the wine, the displayed image can highlight a particular attribute or attributes on the label that correspond to preferred data element fields selected by the user.

The various wines in the DBMS can be placed into taxonomic categories by gathering information about various attributes of the wine from the DBMS, with objective scores, ratings, or weights being assigned to each attribute to determine the appropriate taxonomic category. The assigned weights thus allow any given wine to be assigned to a particular numeric bin, with the bin objectively classifying the wine based on its collective attributes. Wines can be tasted by an expert wine taster as an optional quality control step when the method is used in conjunction with a physical inventory, for example when used by a winery or other business.

Within the scope of the invention, the numeric PTP can be created by numerically modeling or representing the user's unique taste preferences, which are then updated over time based on answers submitted during a web-based interactive interview, or based on other feedback. For example, the interactive interview can present explicit and/or implicit questions regarding the user's sensitivity to particular flavors and/or aromas, with the PTP being updated based on the answers. Likewise, the numeric PTP can be updated by periodically collecting feedback from the user regarding the user's evaluation of wines the user has consumed.

Once a wine has been matched to the user and the recommended wine is displayed on the user's web browser, and if the website providing the recommendation is so configured, the user can then order the recommended wine, followed by fulfillment and shipping of the order. Likewise, using the numeric PTP of the user the user can elect to enroll in a wine-of-the-month (or week, year, etc.) subscription so that a wine conforming to the user's PTP is automatically delivered in the scheduled interval. Alternately or concurrently, different users can elect to be matched by PTP to other users to thereby facilitate a cross-dialogue or social networking of the various users, as set forth herein.

A server-based system for classifying and recommending wine includes a data base management system (DBMS) of one or more databases, and a host machine or server in communication with the DBMS. The DBMS contains a listing of a predetermined inventory of wine, a set of user profiles from various registered users, and information relating to all wines in the inventory, such as objective parameters, a normalized name, and a taxonomic category of each wine. The server includes an algorithm for classifying and recommending wine to a user based on a numeric personal taste profile (PTP) of the user, with the algorithm being adapted for calculating the numeric PTP, automatically matching a wine within the DBMS with the user based on the numeric PTP and a unique bin number of the wine, as will be described herein, and displaying a graphic of the wine label on a web browser of a computer that is accessible by the user. The numeric PTP can be matched in different ways, such as by matching with a numeric PTP of another user to facilitate social networking as noted above.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a host machine or a server-based system that is usable with the method of the invention;

FIG. 2 is a graphical flow diagram illustrating an exemplary embodiment of an algorithm for classifying and recommending wine in accordance with the invention;

FIG. 3 is a graphical flow diagram for the step in FIG. 2 of classifying wine into a taxonomic category;

FIG. 4 is a graphical flow diagram for the step in FIG. 2 of processing a user's specified taste preferences into an objective or numeric personal taste profile (PTP);

FIG. 5 is graphical flow diagram for the step in FIG. 2 of recommending and selecting a wine;

FIG. 6 is a graphical flow diagram for the step in FIG. 2 of creating a normalized universal name for a wine; and

FIG. 7 is a graphical flow diagram for the step in FIG. 2 of fulfilling wine orders or subscriptions to users of the method of FIG. 2.

### DESCRIPTION OF THE PREFERRED EMBODIMENTS

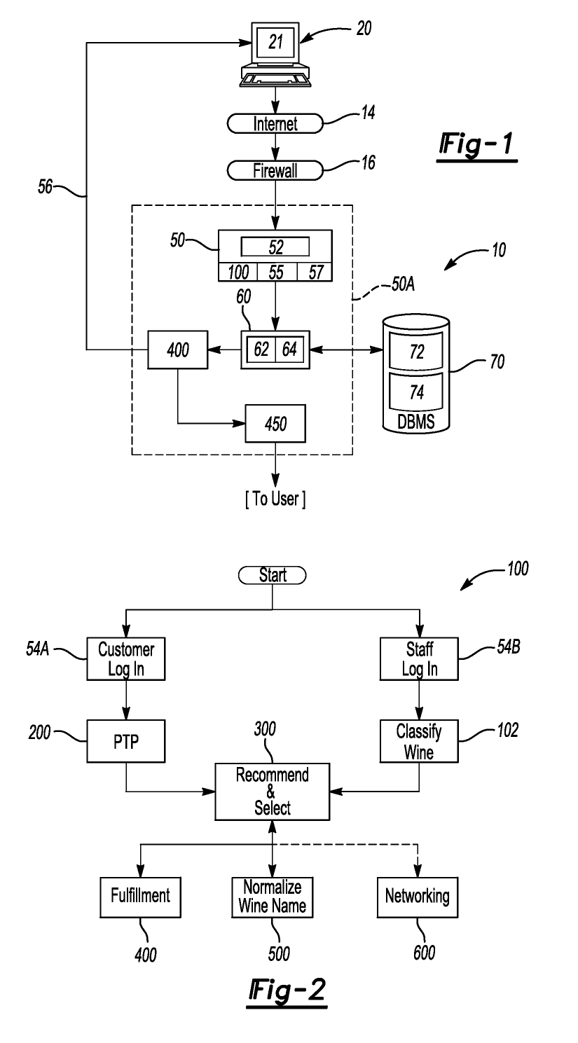

Referring to the drawings, wherein like reference numbers refer to like components throughout the several figures, and beginning with FIG. 1, a computer-based system 10 for classifying and recommending wine includes a host network or data server 50 and a database management system or DBMS 70. The server 50 is accessible using a computer 20 or other suitable electronic device running a web browser 21. That is, the computer 20 and web browser 21 are configured to enable establishment of a network connection to the server 50 over the Internet 14 or over any other suitable communications network. To enhance system security, such a connection can be made through a firewall 16 or other suitable security measures or devices.

The server 50 hosts a website 52 running, for example, Internet Information Services (IIS) or Apache HTTP server. The server 50 can use the hyper text transfer (HTTP) or HTTP secure (HTTPS) protocol. Implementation of the website 52 can include static and dynamic HTML pages, form layouts, business logic, etc., and can be accomplished using, by way of example, dynamic Asynchronous JavaScript and XML (Ajax)-based Web 2.0 application pages. For example, the website 52 can be implemented using the Telerik-Ajax, ASP.net components, and Anthem-Ajax. The components provide Ajax functionality that allows tab switching, star ratings, and tasting note entry to occur, as described below, without the appearance of page switching to a user. The website 52 can be implemented both in a traditional stand-alone form and/or as a Facebook application using the Facebook API.

The server 50 can be configured as a digital computer generally comprising a microprocessor or central processing unit 55, and computer-readable media or memory 57 such as read only memory (ROM), random access memory (RAM), electrically-programmable read only memory (EPROM), etc. The server 50 can also include a high speed clock, analog to digital (A/D) and digital to analog (D/A) circuitry, and input/output circuitry and devices (I/O), as well as appropriate signal conditioning and buffer circuitry. Any algorithms resident in the server 50, or accessible thereby, including the algorithm 100 described below with reference to FIG. 2, can be stored in memory 57 and automatically executed to provide the required functionality.

Still referring to FIG. 1, although shown separately for clarity, the server 50 also includes each of a fulfillment module 400, a matching module 60, and a shipping module 450, as will be described below, each in wired or wireless communication with the server 50, or alternately combined into a single unit as represented by the dotted box 50A. The matching module 60 consist of a matching engine 62 and a matching configuration 64. First-generation matching technology can be implemented using, for example, a full text search on a SQL Server 2000. The current componentized matching technology can be implemented using the commercially-available ELISE tool available from WCC Group, headquartered in The Netherlands, which provides a highly scalable and meaningful matching tools and internal database. However, those of ordinary skill in the art will recognize that the invention is not so limited, and other systems and software are available to achieve substantially the same ends.

The DBMS 70 is made up of one or more databases, exemplified herein as the databases 72, 74 each running on one or more database (DB) servers. The database 72 can include tables that store or hold a predetermined inventory of available wine, as well as a set of user profiles from a set of registered users or customers of the website 52. The database 74 can be populated with the same wine tables, which list substantially all, or as many as practicable, of the different types of commercially available wines, as well as their objective parameters, normalized name, and taxonomic categories, as each of these terms is set forth below. The databases 72, 74 could be separated for performance purposes on two physically separate database servers each running a DBMS 70 without departing from the intended scope of the invention.

The web server 50, the matching module 60, and the DBMS 70 facilitate use of the fulfillment module 400. After the fulfillment module 400 performs its actions, as explained below, the selected wine can be processed by the shipping module 450 and delivered to the customer or user, if the server 50 is so configured. In an exemplary embodiment, these system components are hosted at a hosting facility that would handle all the operational issues associated with hardware setup, backups, redundancy, and failover, as each of these terms is understood in the art.

Referring to FIG. 2, within the scope of the invention the method of classifying and recommending a wine introduced above can be embodied in computer-executable, algorithmic form as the algorithm 100, and recorded or stored in or on a tangible medium within the server 50. The algorithm 100 can be automatically executed by the server 50 of FIG. 1 upon customer login.

Beginning at step 54A, 54B, a user logs in to the server 50 remotely using the computer 20, or more precisely by opening the web browser 21 and entering the URL for the website 52. Steps 54A and 54B differ in the type of user accessing the server 50, with step 54A being used by users who are end users or customers of the website 52, and step 54B being used by users who are more properly described as staff members of the website 52. In either case, a user connects to the server 50 using a computer 20, with the user being prompted for entry of a unique username and password. Session security can be provided, according to an exemplary embodiment, by IIS using clear text password authentication on secured pages. Passwords should be encrypted in the database, along with any associated credit card numbers, with this HTTP layer being secured via secure sockets layer (SSL). The algorithm 100 then proceeds to steps 102 and 200 depending on the type of user that is accessing the server 50.

Referring briefly to FIG. 3, step 102 can be executed by a user in the form of a staff member of the website 52. A new wine is entered into the DBMS 70 along with a corresponding taxonomic category, which in turn will trigger a normalization process at step 500, as described below with reference to FIG. 6. After this has occurred, at step 110 the server 50 or a background process running thereon or on the DBMS 70 will gather information about the wine, such as: country, winery, designation, variety, vintage, and other factors that can be gathered objectively, e.g., soil type and location of vineyard. At step 120, weights can be assigned to the various pieces or information collected at step 110.

The wine can be objectively classified into one of a predetermined number of taxonomic categories that each maps to a particular numeric bin. For example, for white wines, taxonomic categories can be assigned of crisp/light, tangy/zesty, floral/aromatic, floral/lush, sweet, etc. Likewise, for red wines: fresh/fruity, smooth/elegant, earthy, Jimmy, spicy, big/powerful, etc., for rose’: dry/delicate, full/fresh fruit, etc.; for sparkling wines: dry/crisp, on the sweet side, elegant/complex, etc.; for dessert wines: honey/caramel, chocolaty/smooth, big fruit/pow!; etc. Each of these numeric bins has a corresponding percentage value or weight corresponding to a set of attributes of each wine in that bin, with each attribute weighted to determine the overall score or value of the numeric bin, as determined at step 120.

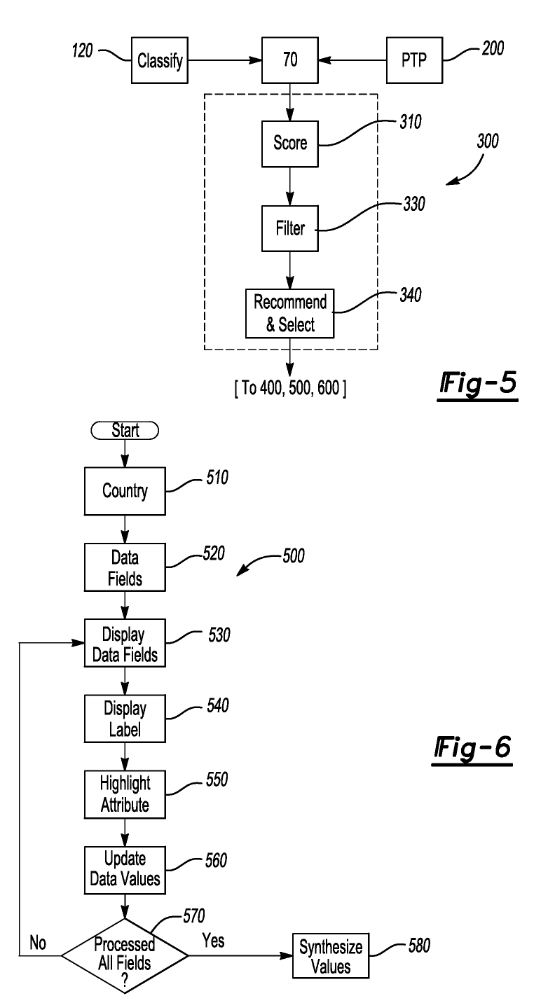

At step 120, the values of the objective data from step 110 and their corresponding percentage values are either, in the first generation, multiplied together, or in the second generation calculated using a matching engine as explained below with reference to FIG. 5, in order to generate weight values for each numeric bin.

At step 130, the wine is then assigned to the numeric bin with the highest weight value. At this point, a user who is a customer has put the wine into the website 52, and the initial classification has taken place automatically by the server 50. For quality assurance, an optional step 140 can be executed by an appropriately trained staff member, who can taste the wine and confirm the bin selection at step 150.

At step 160, the wine is automatically mapped into the appropriate numeric bin for display on the web browser 21, or for use during ranking and scoring of the wine at step 300 of the algorithm 100, as explained below.

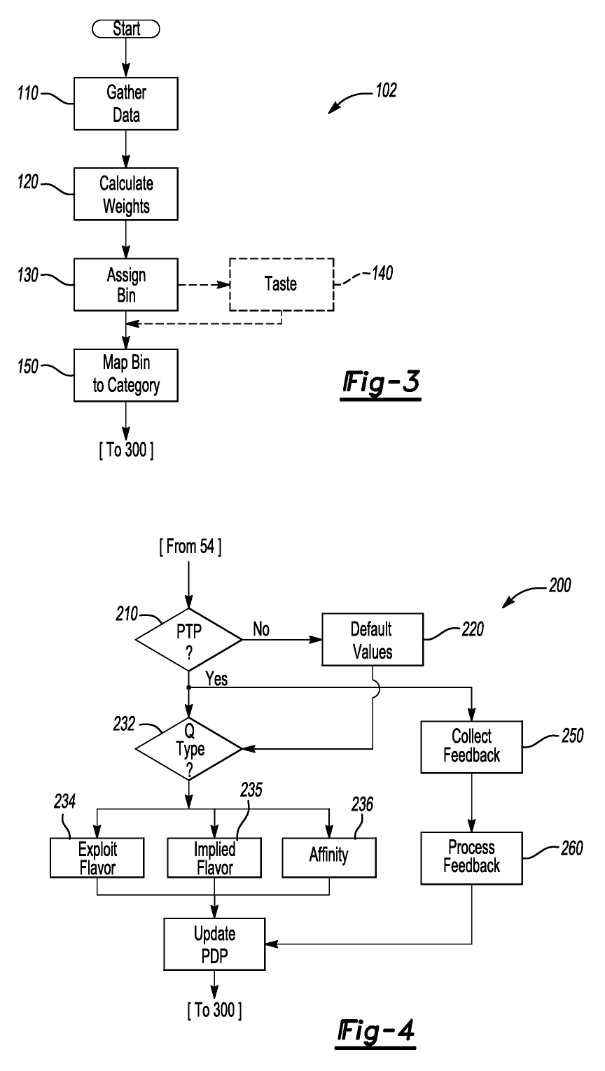

Referring again to FIG. 2 in conjunction with FIG. 4, at step 200 the user updates his or her numeric personal taste profile (PTP). Within the scope of the invention, the algorithm 100 is determined at step 210 if the user currently has an established numeric PTP. If not, the algorithm 100 proceeds to step 220, wherein the server 50 automatically assigns a numeric PTP having default values representing an average or default taste profile.

Beginning at step 232, the user has the opportunity to complete an interactive interview in order to refine the numeric PTP. The interactive interview can be presented to the user as a series of questions, abbreviated Q at step 232 of FIG. 4. During questioning, the question type is determined at step 232, and can be explicit about a preferred wine flavor at step 234, implicit about a preferred wine flavor at step 235, or a confirming question regarding user's affinity for a particular type of food at step 236, or other suitable questions. Each answer to each question can be assigned a weight value that corresponds to one of the bins discussed above. Each question is processed in turn by the server 50 until all are complete. Upon completing all the questions at step 232, the server 50 updates the numeric PTP values at step 240, and then continues with step 300 of FIG. 2.

Still referring to FIG. 4, if the user already has a numeric PTP, the user could be prompted for feedback at step 250. This feedback can consist of asking the user how much the user liked a particular wine, both qualitatively and quantitatively. The user can also be afforded the opportunity to provide feedback on wine tasted in the past. After collecting the feedback at step 250, the feedback can be pre-processed at step 260. To perform step 260, there should be a sufficient number of wines in the DBMS 70. During such preprocessing, the feedback can be adjusted for user biases, wine biases, and population bias using normal statistical methods. Thus, the number of wines in the DBSM should be sufficient to generate a statistically meaningful result, for example approximately 250 wines. The numeric PTP is updated at step 240 as noted above, in this option based on the normalized feedback.

Referring to FIG. 2 in conjunction with FIG. 5, at step 300 the algorithm 100 processes the numeric PTP generated at step 200 and automatically generates a wine recommendation. A list of results 56, including a graphic such as a sample label from the recommended wine, can be displayed on the web browser 21 of the user's computer 20, as noted above. When a wine is not yet in the DBMS 70, the algorithm 100 proceeds to step 500.

At step 310, a ranking or score is generated if the user's numeric PTP is properly stored in the DBMS 70, and if the wine is classified in the DBMS 70. Other conditions 320 for executing the ranking can include, for example, current inventory, the price, historical factors, future factors, customer data, as well as business rules. The ranking and scoring at step 310 can be performed by the ELISE engine noted above, which is configured to take that input and rank every wine against the numeric PTP by calculating the distances between the taste represented in the PTP and the taste represented by the wine classification.

After the wines in the database 70 have been ranked and scored, a list of wines that most closely matches the numeric PTP can be generated. This list can be optionally filtered at step 330 based on business rules, which can include factors such as preferring a more expensive or a cheaper price, or featuring a wine and also how many wines to recommend. If the recommendation at step 300 was triggered by the fulfillment module 400, the filtered list of recommended wines can be shown to a staff member, whereafter a wine can be selected at step 340. If the recommendation at step 300 was triggered as part of viewing the results 56 on the web browser 21, then the full or partial wine ranking or score from step 310 can be automatically displayed at step 350 on the web browser 21.

Referring to FIG. 6, at step 500 a normalization of a wine name is executed. The user, who at this stage is ordinarily a staff member, but could also be a customer without departing from the intended scope of the invention, can be prompted via a drop-down dialog box to select a preferred country of origin at step 510. At step 520, the server 50 makes any appropriate queries to the DBMS 70 in order to choose the data fields for the country selected at step 510. Exemplary data fields can include, by way of example, a winery name, a wine designation, a grape variety, type, and/or vintage, a particular region, appellation, and/or vineyard, desired alcohol content, price, and/or other objective features.

At step 530, the data fields are displayed to the user on the web browser 21 in a web-based format. If the database contains a label for the appropriate wine, the label can likewise be displayed at step 540. At step 550, the website 52 can also highlight the required attribute, both in the data fields as well as on the label, if the label has been displayed at step 540. At step 560, the user can update the data field values if so desired. For example, the value of “cabernet” could be assigned to the “grape variety” field. These updates can be performed via drop-down dialog boxes or text fields with auto complete using Ajax-style background queries or other suitable methods.

After the user has updated the data field value at step 560, step 570 can be executed to determine if all fields have been processed. If all fields have not been processed, step 530 can be repeated, and steps 540, 550, and 560 in turn thereafter. Once all required fields have been processed, step 580 is executed, wherein the server 50 synthesizes the values from steps 510-560 into a universal wine name having the form: country-winery-designation-variety-vintage.

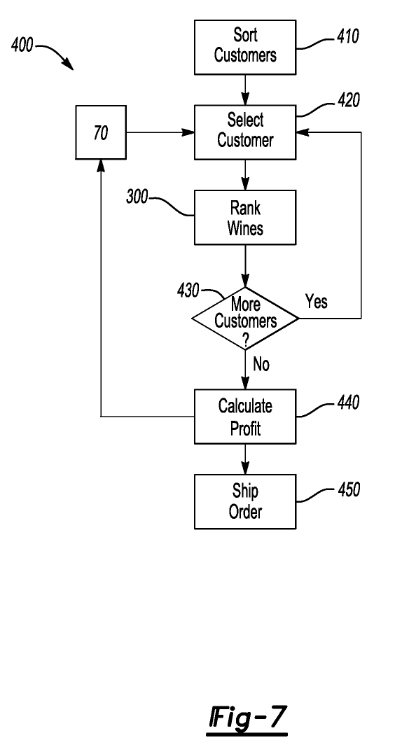

Referring to FIG. 2 in conjunction with FIG. 7, the fulfillment module 400 can fulfill an order entered during any of the forging steps of the algorithm 100. For example, staff members of the website 52 could fulfill a wine subscription to a customer in the following manner: at step 410, all users can be sorted based on customer satisfaction indicators, with those needing improvement being first and those most satisfied being last. The data necessary to perform such a sort can be pulled from the DBMS 70. Next, at step 420 a single customer from the list can be selected and processed. Recommending and selecting at step 300 can be performed for that single selected customer based on the given history and the inventory. Next, at step 430 the algorithm 100 determines if there are additional customers awaiting order fulfillment, and if so, step 420 is repeated, and the next user is selected and processed as set forth above.

When there are no more customers to be processed, the profit for that particular order fulfillment can be calculated at step 440, with the calculation used to update the databases 72 and 74 of the DBMS 70 as needed. At this point, a single wine or set of wines has been selected for each customer. Staff of the website 52 can then, at step 450, ship the selected wines to the corresponding user.

Referring again to FIG. 2, the matching process described above can also be used for social networking purposes to compare and match the numeric PTP of various users, at the user's discretion. For example, once a numeric PTP is determined at step 200, the server 50, using the match module 60, could suggest individuals and/or groups with whom the user shares similar or compatible wine tastes, with the user perhaps making purchasing decisions based upon such comparisons and pairings. That is, users could elect to invite other users having a similar numeric PTP into their network, and once such a network is established, recommendations and suggestions can flow freely between users apart from or in conjunction with the recommendations and suggestions generated at step 300 by the server 50.

While the best modes for carrying out the invention have been described in detail, those familiar with the art to which this invention relates will recognize various alternative designs and embodiments for practicing the invention within the scope of the appended claims.

1. A method for classifying and recommending wine using a data server, the method comprising:
establishing a network connection between the data server and a computer, wherein the computer is accessible by a user and includes a web browser operable for displaying an image to the user;
recording a wine inventory within a database management system (DBMS) of the data server, the wine inventory being a listing of a predetermined number of different wines;
automatically populating the wine inventory with information describing a set of attributes of each of the different wines in the wine inventory;
determining a taxonomic category for each wine by assigning a weighted value to each attribute in the set of attributes for each wine in the wine inventory;
calculating a numeric bin value for each wine using the weighted values;
calculating a numeric personal taste profile (PTP) of the user, wherein the numeric PTP is a number that objectively rates the user's taste preferences;
automatically matching at least one wine in the wine inventory with the user based on the numeric bin value of the wine and the numeric PTP of the user; and
displaying a graphic of the at least one wine on the computer using the web browser.

2. The method of claim 1, wherein automatically populating the wine inventory includes automatically retrieving the set of attributes from the DBMS.

3. The method of claim 1, wherein calculating a numeric PTP includes assigning a default set of numbers as the numeric PTP when the user connects to the data server for the first time, and then updating the numeric PTP of the user over time in response to feedback provided by the user.

4. The method of claim 1, wherein displaying a graphic of the at least one wine includes displaying an image of a sample label of the at least one wine.

5. The method of claim 4, wherein displaying an image of a sample label of the at least one wine includes highlighting at least one of the attributes of the wine on the sample label.

6. A method for classifying and recommending wine using a data server, the method comprising:
establishing an Internet connection between the data server and a computer, wherein the computer is accessible by a user and includes a web browser operable for displaying an image to the user;
recording a wine inventory within a database management system (DBMS) of the data server, the wine inventory data set being a listing of a predetermined number of different wines;
automatically populating the wine inventory with information objectively rating a set of attributes of each of the different wines in the wine inventory;
calculating a numeric bin value for each of the different wines using the set of attributes;
recording input from the user in order to determine a taste preference of the user;
calculating a numeric personal taste profile (PTP) of the user using input from the user, wherein the numeric PTP is a number that objectively rates the taste preference;
automatically matching at least one wine within the wine inventory with the user based on the numeric PTP of the user and the numeric bin values; and
displaying an image of a wine label of the at least one wine on the computer using the web browser.

7. The method of claim 6, wherein the taste preference includes at least one of: an affinity toward a predetermined flavor, an affinity toward a predetermined aroma, and a relative willingness to experiment with new flavors of wine.

8. The method of claim 6, further comprising displaying a user profile of a second user having a numeric PTP that is approximately the same as the numeric PTP of the user to thereby facilitate social networking between the user and the second user.

9. The method of claim 6, wherein displaying an image of a wine label includes highlighting an attribute on the wine label, the attribute being at least one of: a country of origin of the wine, an originating winery of the wine, a variety of the wine, and a vintage of the wine.

10. The method of claim 6, wherein each taxonomic category is determined by gathering a plurality of objective data about a wine through an interactive website running on the data server.

11. The method of claim 6, further comprising: assigning the wine to a numeric bin based on the taxonomic category of the wine, and then verifying the accuracy of the numeric bin using a wine tasting process.

12. The method of claim 6, further comprising:
selecting a wine from a physical inventory of wines based on the PTP of the user; and
shipping the wine to the user.

13. The method of claim 6, further comprising displaying a profile of a second user having a numeric PTP that is approximately the same as the numeric PTP of the user.

14. A server-based system for classifying and recommending wine to a user, the server-based system comprising:
a data base management system (DBMS) including at least one database, wherein the DBMS includes a listing of a predetermined inventory of wine, user profiles from a set of registered users, and a set of objective attributes of each wine in the predetermined inventory of wine; and
a data server in communication with the DBMS, the data server having an algorithm for automatically classifying and recommending a wine to the user based on a numeric personal taste profile (PTP) of the user, wherein the data server is adapted for:
calculating the numeric PTP of the user by objectively rating a taste preference of the user;
automatically matching a wine within the predetermined inventory of wines with the user using the numeric PTP of the user; and
displaying a graphic of a sample label of the wine on a web browser of a computer that is accessible by the user.

15. The system of claim 14, wherein the data server is further adapted for recording an order of the user for the wine that is automatically matched with the user, and for generating a shipping order for at least one bottle of the wine in response to the order.

16. The system of claim 14, wherein the data server is further adapted for comparing the numeric PTP of the user to a set of numeric PTP of other users, for matching a second user to the user based on the comparative value of the numeric PTP, and for displaying a profile of the second user on the web browser to thereby promote social networking between the user and the second user.
